(19) United States
(12) Patent Application Publication
(10) Pub. No.: US 2001/0034952 A1
(43) Pub. Date: Nov. 1, 2001

(54) Lap siding installation tool

(76) Inventor: Steven Edward Mansfield, Houston, TX (US)

Correspondence Address: STEVEN E. MANSFIELD, 1907 HOLLYOAK DR., HOUSTON, TX, 77084, US

(21) Appl. No.: 09/836,563

(22) Filed: Apr. 17, 2001

Related U.S. Application Data
(60) Provisional application No. 60/197,703, filed on Apr. 18, 2000.

(51) Int. Cl. G01D 21/00; B23Q 3/00

(52) U.S. Cl. 33/647

(57) ABSTRACT

The lap siding installation tool is a reusable tool that allows one person to easily handle and install horizontal lap siding on the side of a house or other similar structure. The preferred embodiment of this invention is a simple squared “Z” shaped bracket with spring mechanism that will grip the lower edge of the siding board to be installed. The upper part of the tool provides a “ledge” or “lip” on the backside of the board which will rest on the upper edge of a previously installed board. This “ledge” is in a defined position above the lower edge of the siding board to be installed such that a consistent overlap of the boards is maintained per the lap siding manufacturer's specifications. The board is then fixed to the structure in two (2) places along its upper edge, normally by nails or screws. The tools can then be easily removed by pulling outward on the lower edge of the board a small distance allowing the tools to be pulled downward off of the board.

### CROSS-REFERENCE TO RELATED APPLICATIONS

This application claims the benefit of Provisional Patent Application Ser. No. 60/197703 filed Apr. 18, 2000.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the installation of horizontal lap siding boards on buildings and, more particularly, to a tool used by one person to assist with the proper placement of the siding board that is being installed.

A common means to face a house or similar structure is by using horizontal lap siding. That is, a means of using generally straight, flat wood boards (or in recent years composite and fiber cement planks) and affixing them to a framed structure in horizontal rows where each board or plank overlaps the board or plank below it. Without an aid or tool, teams of workers, usually two per team, have to measure, place and hold the board in place, with the proper overlap, and then fasten the board to the structure. This is generally still the preferred means to install lap siding on homes. While numerous types of devices and tools have been invented to aid in the installation of lap siding onto a building while maintaining a preferred overlap dimension, none have proved very popular to use.

Prior art show devices that attach to or grips the frame of the structure, then allows the new board to be placed onto or into it, which is then affixed to the structure. Examples of this art would be U.S. Pat. No. 5,319,909 issued to Singleterry, U.S. Pat. No. 4,155,175 issued to Stiles and U.S. Pat. No. 3,904,184 issued to Krueger. While the inventions did allow one person to hang siding, the tools were cumbersome and required a significant amount of time to install. The end result was that productivity was not significantly increased.

Other tools were developed that would hook over the top of a previously installed board and provide a temporary base that the new board could be supported on while being fastened to the structure. Examples of this style of art would be U.S. Pat. No. 2,511,083 issued to Small and U.S. Pat. No. 4,208,799 issued to Frantello. The primary drawback to this type of tool was that after the board was fastened to the structure, the tool would have to be moved all the way to the ends of the board to be retrieved. If the end of the board abutted to a window or other obstruction, removal was difficult.

Building upon the simple concept in the previous paragraph, new inventions were made that appeared to overcome their predecessors' shortcomings. In these cases, the tool would be hooked over the top of the board in place, and a new board placed onto the tool. The board would be fastened to the structure and then, by manipulating some mechanical device on the tool, the bottom of the board could be pulled away from the structure and the tool was withdrawn. Examples of this style of art can be found in U.S. Pat. No. 4,473,100 issued to Wheeler, U.S. Pat. No. 4,484,392 issued to Defino and U.S. Pat. No. 5,623,767 issued to Colavito. Depending upon how much of the tool was hooked over the previous board, when the new board was being placed, the tool could be inadvertently knocked off the board. In this case the worker would have to retrieve the tool, put it back into place and start again. Further, these tools would be more complex to manufacture due to the incorporated release mechanism, thus they would be more costly.

U.S. Pat. No. 4,164,346 issued to Sickler defined a tool that was to have been easier to retrieve when the board was installed and simple to manufacture. However, because it only rested on the top edge of the previously installed board, it was very easy to dislodge when attempting to fit the new board into it. This would then require that the workman put down the board he was trying to work with, retrieve the tool and start again.

There are numerous other examples of art, using the same general concepts of tools or devices which would be attached to or grip the structure or previously installed board in order to provide support and lap gauge for the new board to be installed. But for one reason or another, they have not found widespread popularity with the workers installing lap siding.

The present invention provides a different approach to this problem by taking the focus away from the previously installed siding board and focus instead on the new board to be installed. This is accomplished by providing a means to temporarily provide an indexing ledge on the backside of the board to be used for support and lap gauging. The advantages of this concept will become known by reference to the drawings herein and the following description.

### SUMMARY OF THE INVENTION

The present invention is directed to allow one person to easily handle and install horizontal lap siding on the side of a house or other similar structure. The preferred embodiment of this invention is for a pair of tools that will grip the lower edge of the siding board to be installed and provide a “ledge” or “lip” on the backside of the board which will rest on the upper edge of a previously installed board. This “ledge” is in a defined position above the lower edge of the siding board to be installed such that a consistent overlap of the boards is maintained per the lap siding manufacturer's specifications. The board is then fixed to the structure in two (2) places along its upper edge, normally by nails or screws. The tools can then be easily removed by pulling outward on the lower edge of the board a small distance allowing the tools to be pulled downward off of the board.

Accordingly, several objects and advantages of this invention are as follows.

It is an object of this invention to simplify the steps to install lap siding, thus increasing productivity.

It is another object of this invention to provide a set of reusable tools that are used on the piece of siding that is being installed, as opposed to a device that is first installed on a previously installed board or on the structure which will then support the board to be installed.

It is further an object of this invention to provide a simple means to maintain a consistent overlap of the siding boards per manufacture's specifications.

It is further an object of this invention to provide a tool that is inexpensive and easy to manufacture with minimal components.

It is a final object of this invention to provide a tool that is easy to use, such that one person can install lap siding on the side of a structure.

To achieve the foregoing and other objects a spring assisted device for aiding a person in placing lap siding boards onto a building has been invented. The primary embodiment of the invention includes: (1) a “Z” shaped elongated member (bracket) which will support and gauge the board overlap; (2) a spring system that will provide the means to hold item 1 to the board; and (3) a means to fix item 2 to item 1. Using two of these devices enables one person to install lap siding with a consistent overlap onto a building. The devices are affixed onto the board to be installed by pulling the spring trap system away from the bracket and slipping the device onto the bottom of the board such that the bracket is on one side and the spring trap system is on the opposite side, whereby the spring system is released and the device is held to the bottom edge of the board. In this manner, the tool cannot be easily dislodged from the board during installation. With a pair of these tools installed in the same manner, the upper ledges of the “Z” shaped member will protrude perpendicularly outward from the backside of the board. The board is then raised above a previously installed board and lowered onto the upper edge of the board so as to come to rest on the protruding edges of the tools. The person can then fix the upper edge of the board to the structure frame. When the upper edge of the board is fixed, the lower edge of the board is pulled a short distance away from the underlying board that has been overlapped, and the tools are pulled down and off of the board being placed. With the tools removed, the remainder of the board is fastened to the structure framing and the tools are ready to be used again.

Further objects and advantages of my invention will become apparent from consideration of the drawings and ensuing description.

### BRIEF DESCRIPTION OF THE DRAWINGS

The accompanying drawings, together with the descriptions, serve to illustrate the embodiments of the invention.

FIG. 1 is a perspective view of the preferred embodiment of the invention.

FIG. 2 is a side view of the invention as it would be attached to the lower edge of a siding board.

FIG. 3 is a side view of the invention.

FIG. 4 is a front view of the invention.

FIGS. 5 to 8 illustrates, from a side view, the sequence of how the invention is used to assist with the installation of a lap siding board.

FIG. 9 is a side view of an alternate embodiment of a tool embodying various features of the invention.

FIG. 10 is a perspective view of an alternate embodiment of a tool embodying various features of the invention.

FIG. 11 is a side view of another alternate embodiment of a tool embodying various features of the invention.

FIG. 12 is a perspective view of another alternate embodiment of a tool embodying various features of the invention.

FIG. 13 is a side view of yet another alternate embodiment of a tool embodying various features of the invention.

FIG. 14 is a perspective view of yet another alternate embodiment of a tool embodying various features of the invention.

FIG. 15 is a perspective view of the preferred embodiment of the invention in use.

### DETAILED DESCRIPTION OF THE INVENTION

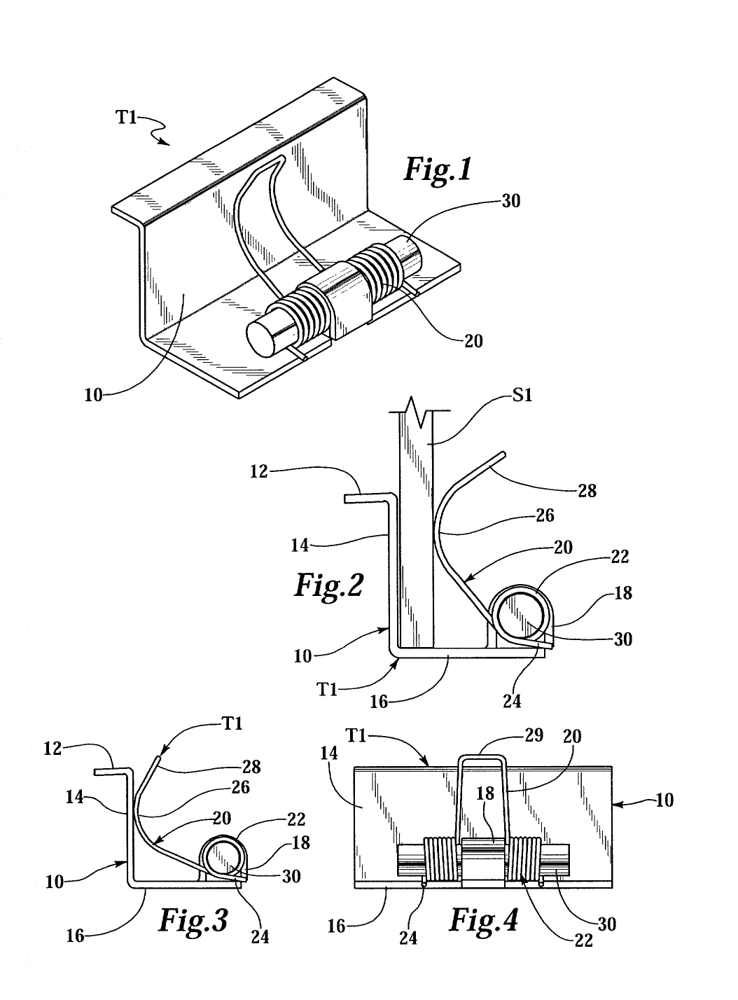

Referring to FIGS. 1 through 4, the preferred embodiment of the lap siding installation tool of the present invention is depicted by reference T1. A lap siding installation tool T1 is comprised of an indexing support bracket 10, a board trap assembly 20 and a trap pin 30.

In the preferred embodiment, the indexing support bracket 10 is formed into a squared “Z” when viewed from the side (FIG. 3). A bracket face 14 of the indexing support bracket 10 is a substantially vertical member and of a fixed length that is equivalent to the desired overlap of the siding boards. An indexing ledge 12 is the horizontal member that extends out from the top of and perpendicular to the bracket face 14. The indexing ledge 12 can also be depressed a couple of degrees from horizontal to provide for better stability in use which would mean that the angle formed by the indexing ledge 12 and the bracket face 14 would be less than 90 degrees. The width of the indexing ledge 12, that is the distance between the outer edge and the bracket face 14, is approximately the same as the thickness of the siding board to be installed S1. A board support shelf 16 of the indexing support bracket 10 is a horizontal member that extends out from the bottom of and perpendicular to the bracket face 14 and is of sufficient length to support a board S1 and allow for the anchoring of a board trap assembly 20.

In the preferred embodiment, a trap anchor 18 is formed by stamping an upside down “U” out of a small center section of the board support shelf 16, located at the furthest edge away from the bracket face 14. The inside diameter of the trap anchor 18 is larger than the diameter of a trap pin 30. The orientation of the trap anchor 18 is such that the trap pin 30 is held parallel to the board support shelf 16. The indexing support bracket 10 can be manufactured by cutting and stamping metal strips, machining a block of material suitable for this use, formed by casting and machining material that is suitable for this use or extrusion and machining a material suitable for this use. In the later three cases, the trap anchor 18 would take the form of a “D” laid over on its flat side with a hole through it of a diameter larger than the diameter of a trap pin 30.

Referring now to a board trap assembly 20, in the preferred embodiment this assembly takes the form of a modified double torsion spring. As such, we will describe one half of the board trap assembly, as the other half is a mirror image. A spring coils 22 comprised of several windings has an inside diameter greater than the outside diameter of a trap pin 30. A spring reaction lever 24 is the outer most component of the board trap assembly 20 and provides the spring reaction against the outer most edge of the board support shelf 16. The spring wire emerging from the inside of the spring coils 22 runs essentially straight for a short distance and then is formed into a board trap 26 which is a concave curve back towards the spring coils 22. From the board trap 26 the wire extends straight as a trap extension 28. A trap grip 29 is bent perpendicular to the trap extension 28 and out of plane with the axis of the spring force, thereby connecting the two mirror halves of the double torsion spring known as the board trap assembly 20.

A trap pin 30 is used to fix the board trap assembly 20 to the indexing support bracket 10. The board trap assembly 20 is positioned to the indexing support bracket 10 with the convex surface of the board trap 26 in contact with the bracket face 14 and positioning each set of spring coils 22 on either side of the trap anchor 18 and with the spring reaction levers 24 in contact with the outer most edge of the board support shelf 16. As this is done, trap pin 30 is passed through the first one spring coils 22, the trap anchor 18 and then the mirror spring coils 22. The trap pin 30 is of sufficient length that some of the trap pin 30 extends out passed each spring coils 22. The trap pin 30 can be constructed as a solid rod or a hollow tube of suitable material that will hold the parts of the lap siding installation tool T1 together.

Referring to FIG. 2, which shows a side view of the lap siding installation tool T1 installed on a board to be installed S1. The board trap 26 is pulled away from the bracket face 14 allowing the board to be installed S1 to be inserted between the board trap 26 and bracket face 14. When the lower edge of the board to be installed S1 comes to rest on the board support shelf 16, the board trap 26 is allowed to come back to rest against the lower outside face of the board to be installed S1. The lap siding installation tool T1 is now held onto the board to be installed S1 with spring tension pinching the back and front faces of the board to be installed S1 between the bracket face 14 and board trap 26. The lower edge of the board to be installed S1 rests on the board support shelf 16. The indexing ledge 12 protrudes from the back face of the board to be installed S1.

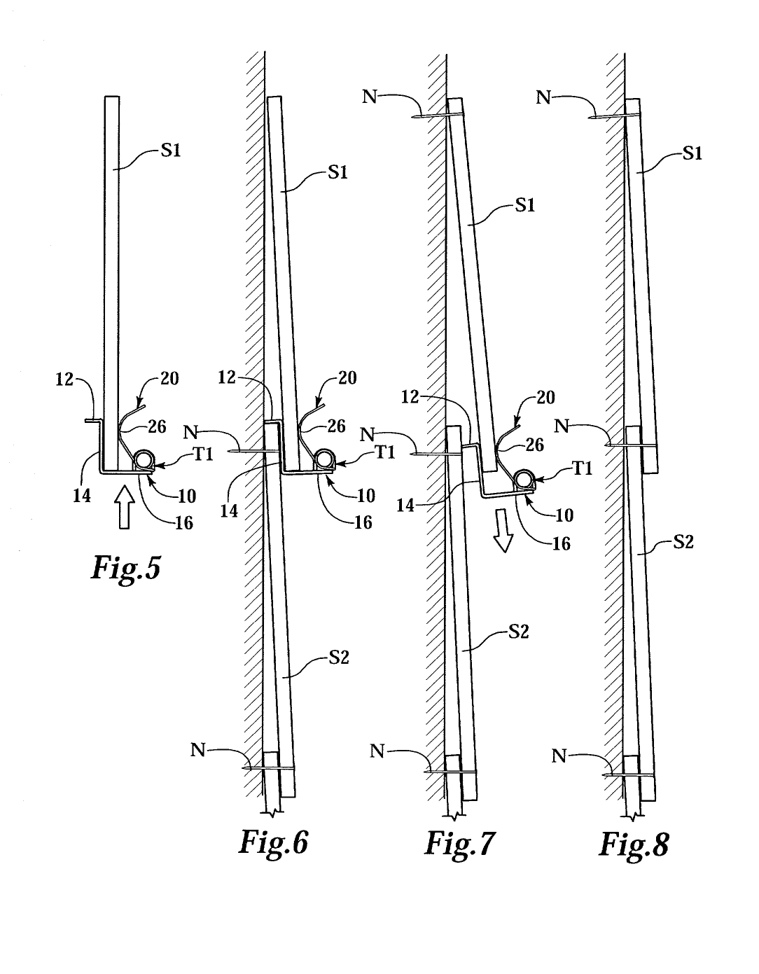

Referring now to FIGS. 5 through 8, a sequence in the use of the lap siding installation tool T1 to assist in the installation of lap siding is illustrated. The first step, depicted in FIG. 5, is to install the tool T1 onto the board to be installed S1. This is accomplished by pulling the board trap 26 back away from the bracket face 14 a sufficient distance to allow the tool T1 to be placed on the lower edge the board to be installed S1. The tool T1 is positioned in such a manner as the lower edge of the board to be installed S1 rests against the board support shelf 16 of the indexing support bracket 10. The bracket face 14 is flat against the backside of the board to be installed S1 and the indexing ledge 12 protrudes out perpendicular from the backside of the board to be installed S1. When the board trap 26 is released, the board trap 26 comes in contact with the front side of the board to be installed S1 and thus “grips” the board to be installed S1 between the bracket face 14 and the board trap 26 using spring tension of the board trap assembly 20.

Referring now to FIG. 6, the board to be installed S1 with the tool T1 attached to it's lower edge, is placed above the top edge of a previously installed board S2 already attached to the structure. The board to be installed S1 is positioned such that the indexing ledge 12 of the indexing support bracket 10 comes to rest on the top edge of the previously installed board S2. With this action accomplished, the lower edge of the board to be installed S1 is at a predetermined overlap with the upper edge of the previously installed board S2 as defined by the length of the bracket face 14. The board to be installed S1 cannot move any further relative to the previously installed board S2 as the indexing ledge 12 and board support shelf 16 prevent further downward movement of the board to be installed S1. The board to be installed S1 is now ready to be fastened to the structure.

Referring now to FIG. 7, a nail N (or screw) is used to fasten the upper edge of the board to be installed S1 to the structure. Once this is performed at two locations spaced apart on the upper edge of the board to be installed S1, the lower edge of the board to be installed S1 is pulled a short horizontal distance out or away from the previously installed board S2. The tool T1 is then removed from the lower edge of the board to be installed S1 by pulling the tool T1 down towards the ground.

Referring now to FIG. 8, following the removal of the tool T1, the board to be installed S1 is then fully fastened by nails N (or screws) to the structure per the manufacturer's recommendation. This completes the procedure for using the tool T1, and this procedure is then repeated for each piece and row of siding boards.

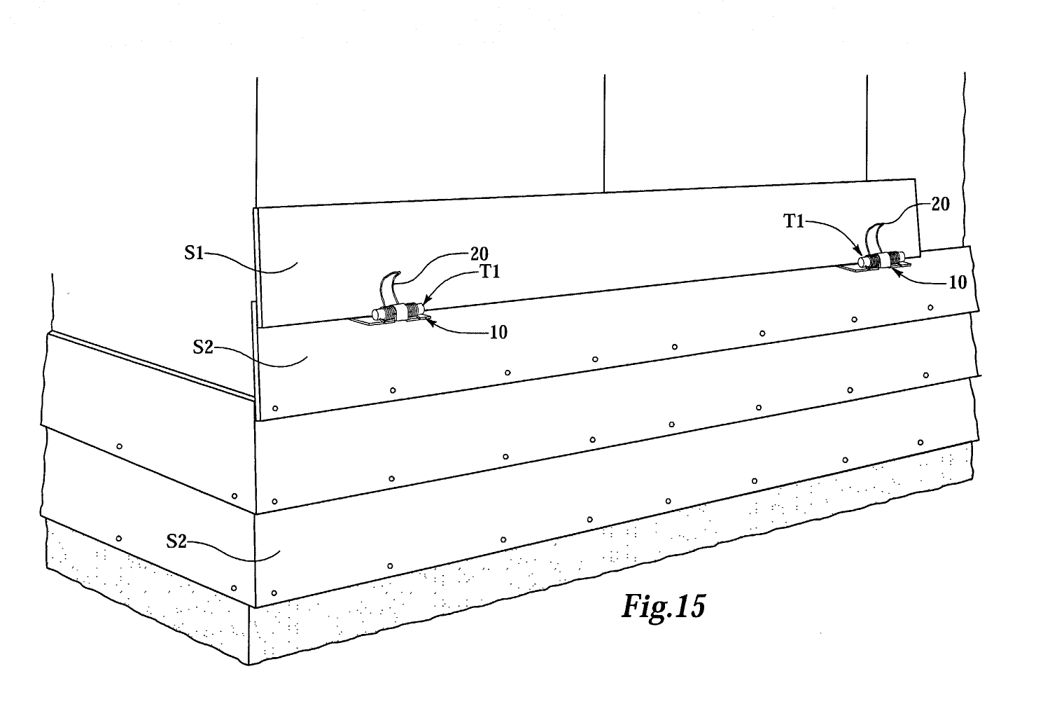

Referring now to FIG. 15, this drawing shows a perspective view of the tool T1 in use on the side of a structure. As is shown a pair of the tool T1 is required to support a board to be installed S1 on a previously installed board S2. The tool T1 is positioned with the board trap assembly 20 to the outside of the board to be installed S1 and sufficient spaced apart to provide stability.

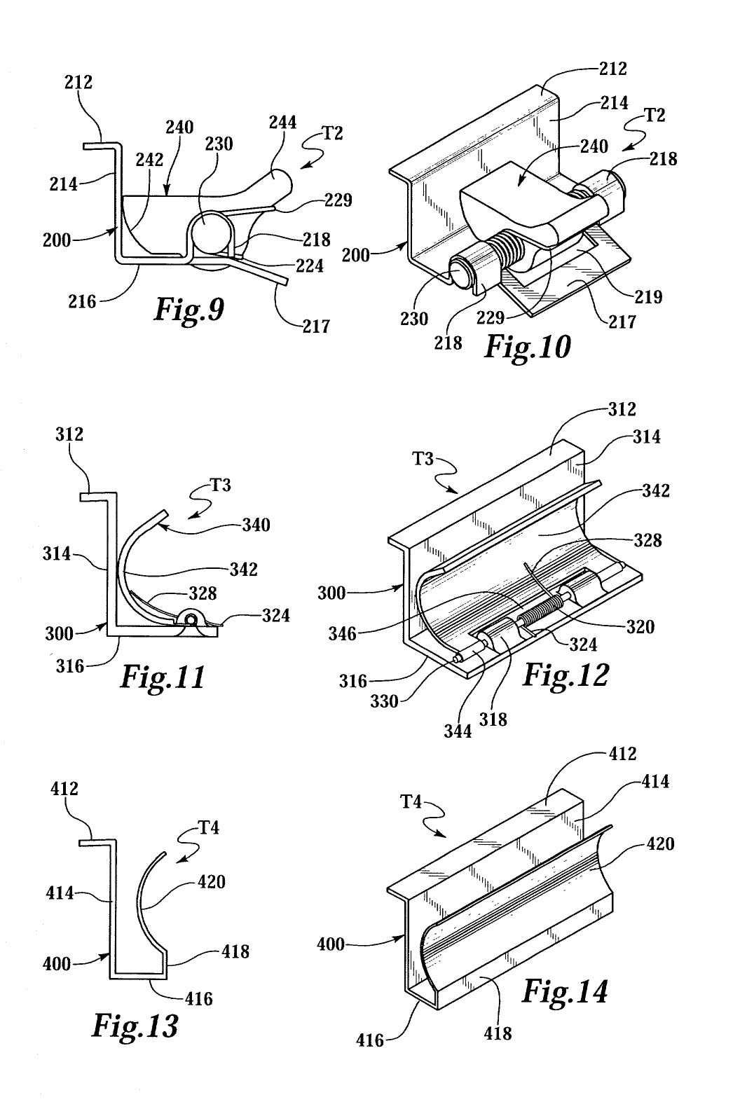

### FIGS. 9 and 10—Additional Embodiment

Referring to FIGS. 9 and 10, an additional embodiment of the lap siding installation tool of the present invention is depicted by reference T2. A lap siding installation tool T2 is comprised of an indexing support bracket 200, a trap spring 229, a trap pin 230 and a board trap 240.

In the additional embodiment of the tool T2, the indexing support bracket 200 is formed into an elongated squared “Z” when viewed from the side (FIG. 9). A bracket face 214 of the indexing support bracket 200 is a substantially vertical member and of a fixed length that is equivalent to the desired overlap of the siding boards. An indexing ledge 212 is the horizontal member that extends out from the top of and perpendicular to the bracket face 214. The indexing ledge 212 can also be depressed a couple of degrees from horizontal to provide for better stability in use which would mean that the angle formed by the indexing ledge 212 and the bracket face 214 would be less than 90 degrees. The width of the indexing ledge 212, that is the distance between the outer edge of the indexing ledge 212 and the bracket face 214, is approximately the same as the thickness of a siding board. A board support shelf 216 of the indexing support bracket 200 is a horizontal member that extends out from the bottom of and perpendicular to the bracket face 214 and is of sufficient length to support a siding board and allow for the anchoring of a board trap 240. A bracket lever 217 is a portion of the indexing support bracket 200 that continues from the end of the board support shelf 216 at a slight downward angle.

In the additional embodiment of the tool T2, a trap anchor 218, of which there are two, is formed by stamping an upside down “U” out of a small section of the board support shelf 216 and bracket lever 217, located at the furthest edge away from the bracket face 214. The inside diameter of the trap anchor 218 is larger than the diameter of a trap pin 230. Each of the two trap anchors 218 are located on opposite ends of the indexing support bracket 200 and on the same axis to hold the trap pin 230 parallel with the board support shelf 216. The indexing support bracket 200 can be manufactured by cutting and stamping metal strips, machining a block of material suitable for this use, formed by casting and machining material that is suitable for this use or extrusion and machining a material suitable for this use. In the later three cases, the trap anchor 218 would take the form of a “D” laid over on its flat side with a hole through it of a diameter larger than the diameter of the trap pin 230.

Referring now to a board trap 240, a solid part that is either machined from a block of suitable material or an extrusion that is cut to length with a hole through it of a diameter slightly larger than the diameter of the trap pin 230. This hole allows the board trap 240 to rotate about the axis of the trap pin 230 and perpendicular to the bracket face 214. The board trap 240 has a board trap face 242, which is manufactured with a convex surface that sweeps away from the bracket face 214 as it approaches the board support shelf 216 moving from top to bottom of the board trap 240. A board trap lever 244 is an extension on the opposite end of the board trap 240 that extends up a short distance at an angle of approximately 35 degrees. A trap access cut-out 219 is made in the board support shelf 216 and bracket lever 217 which allows the board trap 240 to rotate about the trap pin 230 without hindrance by the index support bracket 200. A trap spring 229 of double torsion spring design provides spring energy to the board trap 240. A spring reaction lever 224 is the outer most component of the trap spring 229 and provides the spring reaction against the outer most edge of the board support shelf 216. The spring wire connecting the two spring coils of the trap spring 229 reacts against the underside of the board trap lever 244.

A trap pin 230 is used to fix the board trap 240 to the indexing support bracket 200. The board trap 240 is positioned to the indexing bracket 200 with the convex surface of the board trap face 242 facing towards the bracket face 214. The trap spring 229 is positioned with a set of coils either side of the board trap 240 and with the spring reaction levers 224 in contact with the outer most edge of the board support shelf 216 and the connecting wire of the trap spring 229 under the board trap lever 244. The trap pin 230 is passed through the first trap anchor 218, one trap spring 229 coils, the board trap 240, the second set of spring coils of the trap spring 229 and then the second trap anchor 218. The trap pin 230 is of sufficient length that some of the trap pin 230 extends out passed each trap anchor 218. The trap pin 230 can be constructed as a solid rod or a hollow tube of suitable material that will hold the parts of the lap siding installation tool T2 together.

To open the lap siding installation tool T2 and set on a board to be installed, one would grip the lap siding installation tool T2 by the bracket lever 217 and the board trap lever 244. Squeezing the board trap lever 244 towards the bracket lever 217 will cause the board trap 240 to open away from the bracket face 214. A gap will be formed between the bracket face 214 and the board trap face 242 such that the lower edge of a board to be installed can be inserted between them. Releasing the board trap lever 244 will allow the board trap 240 to rotate towards the indexing support bracket 200, thus pinching the back face and front face of the board to be installed between the bracket face 214 and board trap face 242. The lower edge of the board to be installed will rest on the board support shelf The sequence to use this alternate embodiment of the lap siding installation tool T2 would follow along the same methodology as with the main embodiment of the lap siding installation tool T1 as shown in FIGS. 5 through 8.

### FIGS. 11 and 12—Second Additional Embodiment

Referring now to FIGS. 11 and 12, a depiction of another alternate embodiment of the lap siding installation tool is presented, herein referred to as T3. An indexing support bracket 300 is similarly constructed as the main embodiment with an indexing ledge 312, a bracket face 314 and a board support shelf 316. A trap anchor 318, of which there are two, are smaller than those of the main embodiment and are also located inboard of the outer edges of the board support shelf 316. A board trap 340 is manufactured as a half pipe section with a pin holder 344 at each end and in line with each other, to act as a hinge on a trap pin 330. There is a trap anchor cut-out 346 in the board trap 340 to allow the board trap 340 to rotate about the trap pin 330 without interference from the trap anchors 318. The spring energy for this tool T3 is provided by a trap spring 320 of a single torsion spring design. The trap spring 320 has a spring reaction lever 324 and a spring trap reaction lever 328. To assemble the tool T3, the board trap 340 is held to the indexing support bracket 300 with the convex face of a board trap face 342 touching the bracket face 314. The pin holders 344 are located towards the back edge of the board support shelf 316 and on the outboard sides of the trap anchors 318. The trap spring 320 is inserted in the gap between and in line with the trap anchors 318. The spring reaction lever 324 rests on the outer edge of the board support shelf 316 and the spring trap reaction lever rests against concave side of the board trap face 342. The trap pin 330 is inserted through one pin holder 344, the trap anchor 318, the trap spring 320, the second trap anchor 318 and the second pin holder 344. All components of the tool T3 are manufactured from metal. The sequence to use this second alternate embodiment of the lap siding installation tool T3 would follow along the same methodology as with the main embodiment of the lap siding installation tool T1 as shown in FIGS. 5 through 8.

### FIGS. 13 and 14—Third Additional Embodiment

Referring now to FIGS. 13 and 14, a depiction of another alternate embodiment of the lap siding installation tool is presented, herein referred to as T4. This embodiment of the tool does not require any moving parts. The entire tool can be constructed from one piece of steel, or two pieces that are fastened together. As in the main embodiment, an indexing support bracket 400 has an indexing ledge 412, a bracket face 414 and a board support shelf 416. In this alternate embodiment of the tool T4, the board support shelf 416 can be shorter than in the previous embodiments of the lap siding installation tool. A trap spring 418 extends up a short distance and perpendicular from the outer edge of the board support shelf 416. A board trap 420 which extends vertically from the trap spring 418 and forms an arc roughly parallel to the bracket face 414. The smallest gap between the bracket face 414 and the board trap 420 is smaller than the thickness of a siding board, but the distance between the upper most edge of the board trap 420 and the bracket face 414 is greater than the thickness of the siding board. This allows the tool T4 to clip onto the lower edge of a board to be installed by gripping the lower back face and lower front face of the board to be installed between the board trap 420 and the bracket face 414. In so doing, the lower edge of the board to be installed will rest on the board support shelf and the indexing ledge will protrude out of the back of the board to be installed. The tool T4 is manufactured from steel that is sufficiently thin enough to act as a one piece spring clip, yet sufficiently strong enough to support the weight of a siding board. It is along the junction between the board support shelf 416 and the trap spring 418 that a connection can be made where two pieces could be joined to make this tool T4. One piece would encompass the indexing ledge 412, the bracket face 414, and the board support shelf 416. The second piece would encompass the trap spring 418 and the board trap 420. The two parts could be connected to each other by welding or extended tabs from each that are screwed or riveted together. This method of manufacture would allow the different parts to be fabricated from differing thickness of steel suitable for their requirements. The sequence to use this third alternate embodiment of the lap siding installation tool T4 would follow along the same methodology as with the main embodiment of the lap siding installation tool T1 as shown in FIGS. 5 through 8.

From the descriptions above, a number of advantages of the lap siding installation tool become evident:

a) The tool is used only on the siding board to be installed which keeps the work effort and worker focus on that board.

b) The tools are small, compact and easy to use.

c) The tools require no complex manipulation of locking pins, mechanisms during their use.

d) The tools are constructed by simple manufacturing processes and readily available materials which should keep their cost down.

e) There is no wasted effort installing aids to a structure.

f) The tools are not likely to be knocked off during the performance of the work, yet are easy to remove from the work piece.

Although the description above contains a number of specific embodiments of the invention, these should not construed as limiting the scope of the invention, but merely providing illustrations of some of the presently preferred embodiments of this invention. For example, the board trap could have a more acute internal angle as opposed to sweeping curves, or some parts of the invention could be more square than rectangular, or parts fabricated as two separate components and then joined together by some fashion, etc.

Thus the scope of the invention should be determined by the appended claims and their legal equivalents, rather than by the examples given.

What is claimed is:

1. A reusable tool for the installation on a structure of horizontal lap siding boards, each board having an exposed outside face, a backside face, an upper edge and a lower edge, comprising:
a. a base plate having a vertical wall along one edge where said wall would be of a height equal to the desired overlap of the lap siding boards;
b. said base plate having a length extending away from said wall greater than the thickness of the edge of a lap siding board;
c. said wall portion having a lip extending out approximately horizontal from the upper edge of said wall and in a direction opposite of and approximately parallel with the base plate;
d. said lip extending away from said wall approximately equal to the thickness of the edge of a lap siding board;
e. a means to attach a spring element to the base at or near the edge of the base that is furthest from the vertical wall;
f. a spring element that will come to rest in the direction of the vertical wall such that when the lower edge of a lap siding board is introduced between the vertical wall and said spring element and down against the base plate, said spring element will push against the outside face of the lap siding board and said wall will be brought against the backside face of the lap siding board with enough force to prevent the tool from slipping off of the lap siding board to be installed.

2. A reusable tool for the installation on a structure of horizontal lap siding boards, each board having an exposed outside face, a backside face, an upper edge and a lower edge, comprising:
a. a base plate having a vertical wall along one edge where said wall would be of a height equal to the desired overlap of the lap siding boards;
b. said base plate having a length extending away from said wall greater than the thickness of the edge of a lap siding board;
c. said wall portion having a lip extending out approximately horizontal from the upper edge of said wall and in a direction opposite of and approximately parallel with the base plate;
d. said lip extending away from said wall approximately equal to the thickness of the edge of a lap siding board;
e. a means to attach a spring element to the base at or near the edge of the base that is furthest from the vertical wall;
f. a means to attach a rotational element that can rotate along an axis near and parallel to the base plate edge furthest from the vertical wall where said rotational element could touch or nearly touch the vertical wall;
g. a spring element that will react against the rotational element causing said rotational element to come to rest in the direction of or against the vertical wall such that when the lower edge of a lap siding board is introduced between the vertical wall and said rotational element and down against the base plate, said rotational element will push against the outside face of the lap siding board and said wall will be brought against the backside face of the lap siding board with enough force to prevent the tool from slipping off of the lap siding board to be installed.
